(19) United States
(12) Patent Application Publication
(10) Pub. No.: US 2024/0190629 A1
(43) Pub. Date: Jun. 13, 2024

(54) DOUBLE OUTLET CAPSULE PACKAGING CONTAINER

(71) Applicant: SHANGHAI JND PLASTIC PRODUCTS CO., LTD., Shanghai (CN)

(72) Inventors: Yixin HUANG, Shanghai (CN); Xinrui ZHANG, Shanghai (CN)

(21) Appl. No.: 18/105,947

(22) Filed: Feb. 6, 2023

Related U.S. Application Data
(63) Continuation of application No. PCT/CN2022/141301, filed on Dec. 23, 2022.

(30) Foreign Application Priority Data
Dec. 7, 2022 (CN) 202211567128.7

(51) Int. Cl. B65D 51/28; B65D 53/02

(52) U.S. Cl. CPC B65D 51/28; B65D 53/02

(57) ABSTRACT

The present application provides a double outlet capsule packing container, including a housing body, in which a partition portion is provided in the housing body, the partition portion divides the housing body into two chambers, one chamber is a connection portion, and the other chamber is a storage portion, the storage portion is configured for containing materials and a first sealing portion is connected at an opening of the storage portion.

### CROSS-REFERENCE TO RELATED APPLICATION

This application is a continuation of PCT application No. PCT/CN2022/141301, filed on Dec. 23, 2022, which claims the priority and benefit of Chinese patent application serial no. 202211567128.7, filed on Dec. 7, 2022. The entireties of PCT application No. PCT/CN2022/141301 and Chinese patent application serial no. 202211567128.7 are hereby incorporated by reference herein and made a part of this specification.

### TECHNICAL FIELD

The present application relates to a field of a container and in particular, relates to a double outlet capsule packing container.

### BACKGROUND ART

A technology of a sealing cover with materials stored therein exists in the current technical solutions. However, the opening method thereof is using the external force to open and pouring the material in the bottle to be dissolved and soaked. It can be seen that, the steps of storing, opening, and incorporating the material into the bottle are separate and discontinuous. In one aspect, this operating method has a plurality of steps. In the other aspect, the material is easy to spill influenced by the opening methods of the material, the pouring angle of the material into the bottle, or the site environment such as wind speed.

There are two kinds of capsule packing containers provided in the existing technology. One capsule is separated from the bottle, and can be individually carried. This kind of capsule can only be opened from top to bottom when using, which has a single opening method. Another design of the capsule is integrated with the bottle. This kind of capsule is sold with the bottle, and the capsule can only be suitable for one single kind of bottle. And it is required to tear off the sealing film at the bottom of the capsule when using.

### SUMMARY

A capsule packing container in an individual design is lacked in the existing technology, which can not only be opened from the bottom after connecting to the bottle, but also be opened from the top so that the material therein can be poured out, which is used for solving the problem of single opening method of the product.

The present application provided a double outlet capsule packing container in order to solve the above technical problem, which includes a housing body, in which a partition portion is provided in the housing body, the partition portion divides the housing body into two chambers, one chamber is a connection portion and the other chamber is a storage portion, the storage portion is configured for containing materials and a first sealing portion is connected at an opening of the storage portion.

In some embodiments, when the connection portion is connecting to a bottle mouth, the bottle mouth continuously applies a pressure to the partition portion so that the partition portion is separated from an inner wall of the housing.

In some embodiments, the first sealing portion is a film for sealing the storage portion, the film adopts an aluminum film or a plastic film.

In some embodiments, a second sealing portion is provided on an end of the storage portion away from a bottom of the connection portion.

In some embodiments, a threaded structure is provided in an inner wall of the connection portion for connecting to the bottle mouth.

In some embodiments, the partition portion is integrated with the housing body, an inner diameter of the partition portion is matched with an inner diameter of the housing body, and the partition portion is separated from the inner wall of the housing body under an external force in a direction from bottom to up.

In some embodiments, a thickened area is provided at a connection position between an outer edge of the partition portion and the inner wall of the housing body, and the thickened area is always connected with the housing body.

In some embodiments, the partition portion is horizontally or obliquely arranged in the housing body.

In some embodiments, a protrusion portion is provided on a contacting area between a bottom of the partition portion and the bottle mouth, and the protrusion portion is a protruded block, a protruded point, or a rhombic corner.

In some embodiments, an anti-leak area is provided at a connection position between the housing body and the partition portion, the anti-leak area is configured to be snapped in the bottle mouth, and the anti-leak area is an anti-leak ring.

The present application has the following technical effects and advantages.

1. When using the present application, the first sealing portion is torn off, the material in the housing body is poured in the cup. The first sealing portion doesn't have to be torn off. The connection portion is tightly screwed with the bottle mouth, the bottle mouth breaks the partition portion, the material can drop in the bottle from the gap between the partition portion and the housing body. The present application has two opening methods. The bottle can be any container for containing liquid, such as a cup, a can, and a bowl.

2. Material is stored in the storage portion of the housing body in the present application. The capacity is the amount to be supplemented at one time. The material is obtained by any of the two opening methods when using, solving the problem of a short quality guarantee period of the material in the storage portion after opening.

3. The partition portion is integrated with the housing body in the present application. The storage portion is configured to containing the material. The material includes but is not limited to powder, liquid or granule. The first sealing portion at the opening of the storage portion has a role of sealing.

4. In the present application, the bottle breaks the partition portion after the threaded structure of the connection portion is connected to the bottle mouth. The material can drop in the bottle from the gap between the partition portion and the housing body, and be homogeneously mixed to be taken, reducing the contact between the material and the external environment and ensuring the quality of the material.

5. The second sealing portion of the connection portion and the first sealing portion of the storage portion paly a dustproof role in the present application. An additional package of the housing body is not required. The storage of material and the dustproof function can be realized in a low cost.

6. The anti-leak area abuts against the bottle mouth during using in the present application, which can prevent the material from leaking from the portion between the bottle mouth and the connection portion. The edge of the anti-leak ring is arc shaped, which can be better matched with the external edge of the bottle mouth, having a better sealing effect.

### BRIEF DESCRIPTION OF THE DRAWINGS

FIG. 1 is a structural schematic diagram of a double outlet capsule packing container with a screw thread according to an embodiment of the present application.

FIG. 2 is a structural schematic diagram of a housing body according to Embodiment 1 of the present application.

FIG. 3 is an enlarged schematic diagram of a portion A in FIG. 2 according to Embodiment 1 of the present application.

FIG. 4 is a section diagram of a housing body according to Embodiment 1 of the present application.

FIG. 5 is a structural schematic diagram of a first housing body according to Embodiment 2 of the present application.

FIG. 6 is a section diagram of a first housing body according to Embodiment 2 of the present application.

FIG. 7 is an enlarged schematic diagram of a portion B in FIG. 6 according to Embodiment 2 of the present application.

FIG. 8 is a structural schematic diagram of a second housing body according to Embodiment 3 of the present application.

FIG. 9 is a section diagram of a second housing body according to Embodiment 3 of the present application.

FIG. 10 is a structural schematic diagram of a third housing body according to Embodiment 4 of the present application.

FIG. 11 is a top view diagram of a third housing body according to Embodiment 4 of the present application.

FIG. 12 is a section diagram of a third housing body according to Embodiment 4 of the present application.

FIG. 13 is an enlarged diagram of a portion C in FIG. 12 according to Embodiment 4 of the present application.

### DETAILED DESCRIPTION

The present application is further described in detail below in combination with drawings and embodiments. The embodiments of the present application are given for examples and descriptions, which may have omissions, and is not intended to limit the disclosure form of the present application. a plurality of modifications and changes are obvious for those skilled in the art. The election and the described embodiments is intended to better explain the principle and actual application of the present application, so that those skilled in the art can understand the present application to design various embodiments suitable for specific purposes with various modifications.

The following description chooses the protein powder as the material for explanation.

The protein powder adopts the purified soybean protein. The protein is the most important nutrient ensuring the physical health, which is necessary for maintaining and repairing the organism and the cell growth. The protein not only influences the growth of the organism tissues such as muscles, but also participates in the hormone generation, immune function maintenance, transport of other nutrients and oxygen, hemoglobin production and blood coagulation. The normal mental worker needs 0.8-1.0 grams of protein per kilogram of body weight every day. The demand of athletes and bodybuilders engaged in high-intensity sports is 2-3 times thereof.

The existing protein powder package is barreled. The bodybuilder takes out the protein powder from the barrel using the spoon and then brews the powder. However, the barreled protein powder needs to be stored under a dry environment after opening, which needs to be used up within 2-6 months, greatly reducing the quality guarantee period. If the protein powder isn't used up in a short term, it may lead to the waste of the protein powder.

Therefore, a capsule packing container is provided based on the above problems to pack the protein powder in a single intake amount.

However, there are two kinds of capsule packing containers provided in the existing technology. One capsule is separated from the bottle and can be individually carried. This kind of capsule can only be opened from top to bottom when using, which has a single opening method. Another design of the capsule is integrated with the bottle. This kind of capsule is sold with the bottle, and the capsule can only be suitable for one single kind of bottle. And it is required to tear off the sealing film at the bottom of the capsule when using. A capsule packing container in an individual design is lacked in the existing technology, which can not only be opened from the bottom after connecting to the bottle, but also be opened from the top so that the material therein can be poured out, which is used for solving the problem of single opening method of the product.

The present application provides a double outlet capsule packing container in order to solve the above problem.

### Embodiment 1

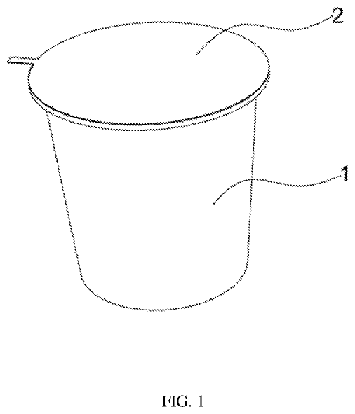

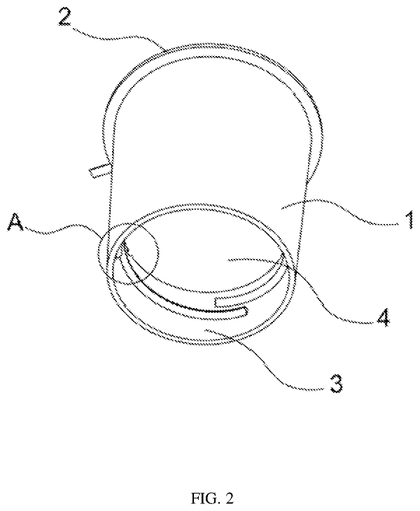

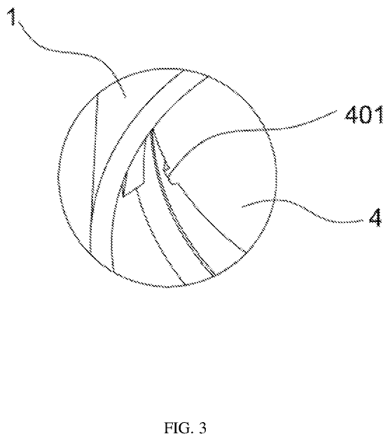

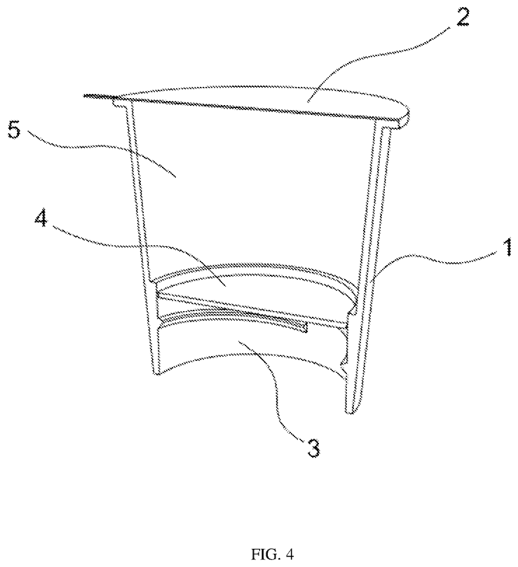

Referring to FIGS. 1-4, the present application provides a double outlet capsule packing containing including a housing body 1. A partition portion 4 is provided in the housing body 1. The partition portion 4 is integrated with the housing body 1. A thickened area 401 is provided at a connection between an outer edge of the partition portion 4 and an inner wall of the housing body 1. The thickness of the connection position between the partition portion 4 and the housing body 1 is smaller than the thickness of the partition portion. Therefore, the partition portion 4 can be separated from the inner wall of the housing body 1 under an external force, while the thickened area 401 keeps in connection with the housing body 1 after the partition portion 4 separating from the inner wall of the housing body 1 to prevent the partition portion 4 from entering a bottle mouth. The partition portion 4 divides the housing body 1 into two chambers, one chamber is a connection portion 3, in which a screwing structure is provided on the inner wall of the connection portion, and the other chamber is a storage portion 5, which is configured for containing the material. The material can be dissolved in the water and the material is not limited to powder, liquid or granule. A first sealing portion 2 is connected at an opening of the storage portion 5 to prevent the dust from entering the storage portion 5.

In this embodiment, a bottle containing the mineral water is taken as example for explanation. The connection portion 3 is aligned with the bottle mouth. The housing body 1 is screwed, so that the screwing structure of the connection portion 3 is connected to the bottle mouth and the bottle mouth is inserted in the housing body 1. When the bottle mouth abuts against the partition portion 4, a resistance force can be obviously felt. Then the housing body 1 is screwed again. The partition portion 4 except the thickened area 401 is broken and separated from the housing body 1 under the extrusion of the bottle mouth. The material enters the bottle from a gap between the partition portion 4 and the housing body 1. The bottle is shaken to fully mix the material and water. The material won't be contacted with the external environment before and after entering the bottle in this method, preventing the material from getting wet. After the housing body 1 is taken out, the water can be directly drunk through the bottle mouth. The partition portion 4 of the housing body 1 is opened by rotating. The bottle mouth continuously applies pressure on the partition portion 4, so that the partition portion 4 is partly separated from the housing body 1. The required force is smaller than the force for screwing the sealing cover, which is easy to operate.

Further, a film of the storage portion 5 can play a sealing role. The housing body 1 doesn't require an additional package. The material storage and the dustproof function can be realized in a low cost. The film is torn off and the material in the housing body 1 is poured in the cup. The film doesn't have to be torn off. The connection portion 3 is tightly screwed with the bottle mouth, the bottle mouth breaks the partition portion 4, the material can drop in the bottle from the gap between the partition portion 4 and the housing body 1. The present application has two opening methods.

The material is stored in the storage portion 5 of the housing body 1. The housing body 1 can be manufactured in different sizes, in which the housing body 1 with a larger size has a larger capacity of the storage portion 5 so as to contain more material, which is suitable for different bodybuilders of different weights. In addition, the amount of the packed material is constant, which may not lead to a waste caused by taking too much material. The housing body 1 is single used. The material is in a sealing stated before opening the sealed storage portion 5. The quality grantee period thereof is same with that of the barreled material, which is generally 12-18 months. The partition portion 4 is broken after the housing body 1 is connected to the bottle mouth, the material can directly enter the bottle to mix with the water.

### Embodiment 2

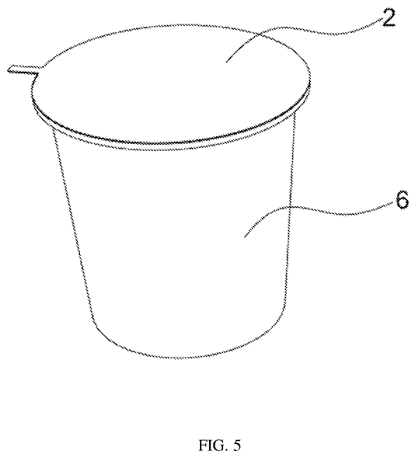

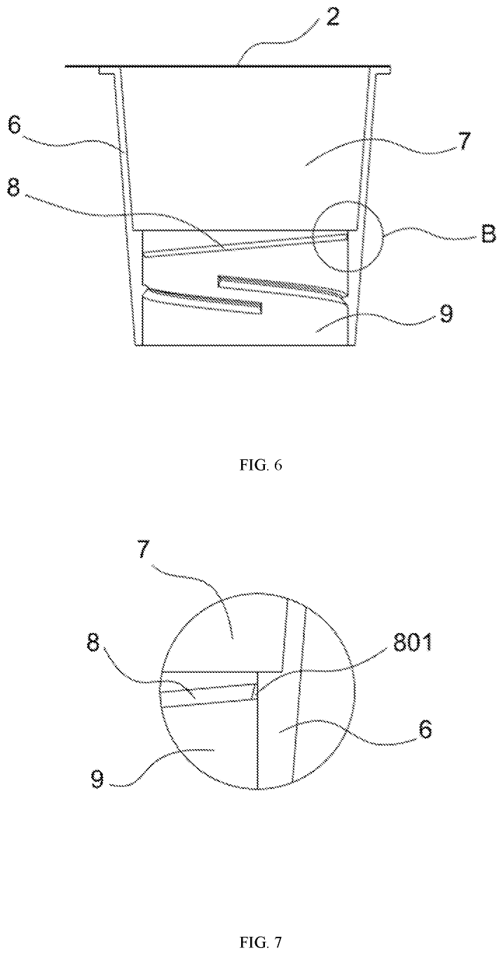

Referring to FIGS. 5-7, according to Embodiment 1, the housing body 1 is a first housing body 6. A first partition plate 8 is provided in the first housing body 6. The partition plate 8 is inclinedly arranged. A first thickened area 801 is provided at the edge of the first partition plate 8. The first thickened area 801 is positioned at a highest contacting point between the first partition plate 8 and the housing body 1. The partition plate 8 divides the first housing body 6 into a storage chamber 7 for containing the material and a connection chamber 9. A screwing structure is provided on an inner wall of the connection chamber 9. A first sealing portion 2 is adhesively connected to the first housing body 6 at the storage portion 5. A second sealing portion is adhesively connected to the first housing body 6 at the connection portion 3. The first sealing portion 2 and the second sealing portion are not limited to the aluminum films, a plastic film or the other film that can reach the sealing effect can also be adopted. The first sealing portion 2 and the second sealing portion can prevent the dust from entering the first housing body 6.

In this embodiment, the second sealing portion is torn off, the connection chamber 9 of the first housing body 6 is connected to the bottle mouth, and the bottle mouth is inserted in the first housing body 6. The lowest portion of the first partition plate 8 is pressed, the lowest portion of the partition plate 8 is firstly separated from the inner wall of the first housing body 6, and gradually enters in the first housing body 6 with the bottle mouth. The first partition plate 8 is broken while the first thickened area 801 is connected to the first housing body 6. The material enters the bottle from the gap between the first partition plate 8 and the first housing body 6. The bottle is shaken to fully mix the material and water. The material won't be contacted with the external environment before and after entering the bottle in this method, preventing the material from getting wet. After the first housing body 6 is taken out, the water can be directly drunk through the bottle mouth.

Further, the first sealing portion 2 and the second sealing portion can play a sealing role. The first housing body 6 doesn't require an additional package. The material storage and the dustproof function can be realized in a low cost. The first sealing portion is torn off and the material in the first housing body 6 is poured in the cup. The first sealing portion 2 doesn't have to be torn off. The connection portion 3 is tightly screwed with the bottle mouth, the bottle mouth breaks the partition plate 8, the material can drop in the bottle from the gap between the partition plate 8 and the first housing body 6. The present application has two opening methods.

The material is stored in the storage chamber 7 of the first housing body 6. The first housing body 6 can be manufactured in different sizes, in which the first housing body 6 with a larger size has a larger capacity of the storage chamber 7 so as to contain more material, which is suitable for different bodybuilders of different weights. In addition, the amount of the packed material is constant, which may not lead to a waste caused by taking too much material. The first housing body 6 is single used. The material is in a sealing stated before opening the sealed storage chamber 7. The quality grantee period thereof is same with that of the barreled material, which is generally 12-18 months. The partition plate 8 is broken after the first housing body 6 is connected to the bottle mouth, the material can directly enter the bottle to mix with the water.

### Embodiment 3

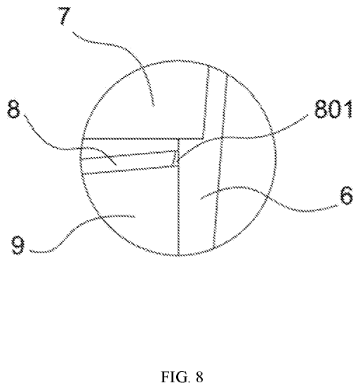

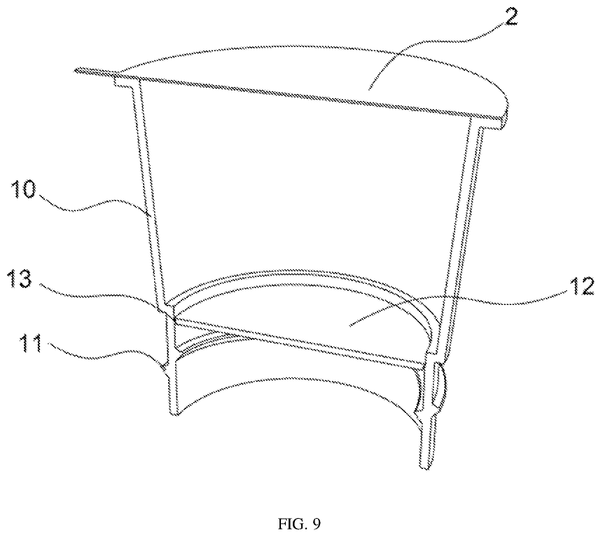

Referring to FIGS. 8-9, based on Embodiment 1, the housing body 1 is a second housing body 10. An external thread 11 is provided on the outer wall of the second housing body 10 at the bottom thereof. A second sealing portion is connected to the second housing body 10. A second partition plate 12 is provided in the second housing body 10. The second partition plate 12 divides the second housing body 10 into a storage chamber and a connection chamber. The second sealing portion can adopt a film connecting at the bottom of the connection portion or adopt a sealing cover. The sealing cover is matched with the external thread 11 of the connection chamber to realize a sealing connection. A first sealing portion 2 is adhesively connected at the storage chamber. The first sealing portion 2 and the sealing cover can prevent the dust from entering the second housing body 10. A second thickened area 13 is provided at the connection position between the outer edge of the second partition plate 12 and the second housing body 10.

In this embodiment, the sealing cover at the bottom of the second housing body 10 is torn off, the second housing body 10 is connected to the bottle mouth, and the bottle mouth is inserted in the second housing body 10. The second partition plate 12 is pressed at the bottle mouth, the edges of the second partition plate 12 expect the second thickened area 13 is broken. The material enters the bottle from the gap between the second partition plate 12 and the second housing body 10. The bottle is shaken to fully mix the material and water.

Further, the film and the sealing cover can play a sealing role. The second housing body 10 doesn't require an additional package. The material storage and the dustproof function can be realized in a low cost. The film is torn off and the material in the second housing body 10 is poured in the cup. The film doesn't have to be torn off. The connection portion is tightly screwed with the bottle mouth, the bottle mouth breaks the second partition plate 12, the material can drop in the bottle from the gap between the second partition plate 12 and the second housing body 10. The present application has two opening methods.

The material is stored in the storage chamber 7 of the second housing body 10. The second housing body 10 can be manufactured in different sizes, in which the second housing body 10 with a larger size has a larger capacity of the storage chamber 7 so as to contain more material, which is suitable for different bodybuilders of different weights. In addition, the amount of the packed material is constant, which may not lead to a waste caused by taking too much material. The second housing body 10 is single used. The material is in a sealing stated before opening the sealed storage chamber 7. The quality grantee period thereof is same with that of the barreled material, which is generally 12-18 months. The second partition plate 12 is broken after the connection chamber is connected to the bottle mouth, the material can directly enter the bottle to mix with the water.

### Embodiment 4

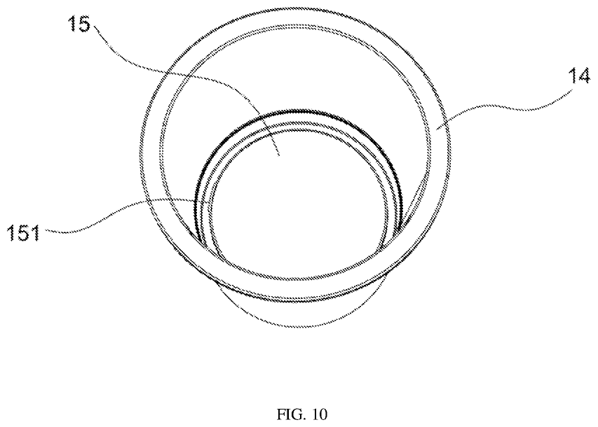

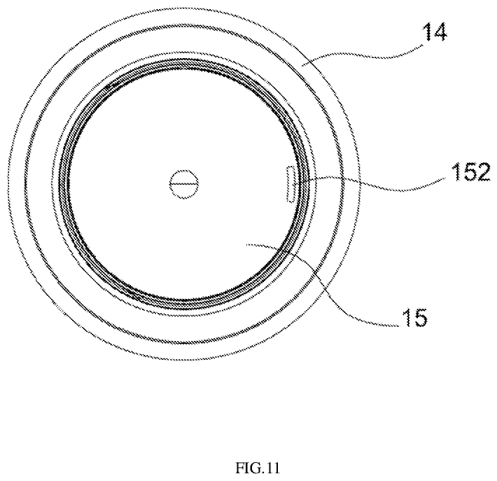

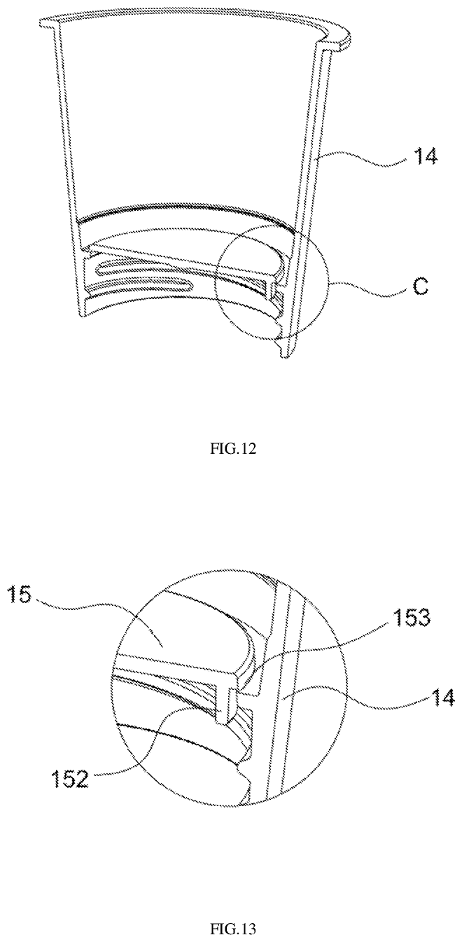

Referring to FIGS. 10-13, the housing body 1 is a third housing body 14 based on the embodiments 1, 2 and 3 in order to realize a better breaking effect. A third partition plate 15 is provided in the third housing body 14. A third thickened area 151 is provided at the connection position between the outer edge of the third partition plate 15 and the third housing body 14. A protruded block 152 is provided at the bottom of the third partition plate 15, which is away from the third thickened area 151. The protruded block 152 preferentially abuts against the bottle mouth during using, so that the thin edge at the protruded block 152 is broken firstly. It is labor saving when screwing the bottle. The connection position between the third partition plate 15 and the third housing body 14 except the third thickened area 151 is an anti-leak area 153. The 20 anti-leak area 153 is an anti-leak ring. The thickness of the anti-leak area 153 is relatively small. After the bottle mouth abuts against the protruded block 152, the third partition plate 15 is pressed upwards, the position of the third partition plate 15 close to the protruded block 152 is broken and separated from the third housing body 14. The bottle mouth abuts against the anti-leak ring. It should be noted that it is required to shake the bottle after the material entering the bottle, so that the material can be fully incorporated into the liquid in the bottle. It can effectively prevent the overflow of materials from the threaded opening of the bottle mouth by increasing the contact between the anti-leak ring and the bottle mouth.

The bottle mouth firstly abuts against the protruded block 152 after the third housing body 14 is connected to the bottle mouth. The edge of the third partition plate 15 close to the protruded block 152 is firstly separated from the third housing body 14. The bottle mouth is further screwed in the third housing body 14 to break the third partition plate 15, so that the material can directly enter the bottle to mix with the water.

Further, the anti-leak ring abuts against the top edge of the bottle mouth after the top of the bottle mouth and the anti-leak ring are contacted, so as to form a blockage, avoid the overflow from the gap between the third housing body 14 and the bottle mouth when material are dropping.

It is obvious that the above are only a part of the embodiments of the present application rather than all embodiments. The other embodiments obtained by those skilled in the art based on the embodiments in the present application without inventive efforts should belong to the protection scope of the present application. The structures, devices and operating methods without specific explanation and limitation, that are not described in detail and explained in the present application are implemented according to the conventional manner in the art.

What is claimed is:

1. A double outlet capsule packing container, comprising: a housing body, wherein a partition portion is provided in the housing body, the partition portion divides the housing body into two chambers, one chamber of the two chambers is a connection portion, and a second chamber of the two chambers is a storage portion, and a first sealing portion is connected at an opening of the storage portion.

2. The double outlet capsule packing container according to claim 1, wherein, when the connection portion is connected to a bottle mouth, the bottle mouth continuously applies a pressure to the partition portion so that the partition portion is separated from an inner wall of the housing body.

3. The double outlet capsule packing container according to claim 2, wherein, the first sealing portion is a film for sealing the storage portion.

4. The double outlet capsule packing container according to claim 3, wherein, the film is an aluminum film or a plastic film.

5. The double outlet capsule packing container according to claim 1, wherein, a second sealing portion is provided on an end of the storage portion away from a bottom of the connection portion.

6. The double outlet capsule packing container according to claim 1, wherein, a threaded structure is provided in an inner wall of the connection portion.

7. The double outlet capsule packing container according to claim 6, wherein, the partition portion is integrated with the housing body, an inner diameter of the partition portion is matched with an inner diameter of the housing body, and the partition portion is separated from an inner wall of the housing body under an external force in a direction from bottom to top.

8. The double outlet capsule packing container according to claim 7, wherein, a thickened area is provided at a connection position between an outer edge of the partition portion and the inner wall of the housing body, and the thickened area is always connected with the housing body.

9. The double outlet capsule packing container according to claim 8, wherein, the partition portion is horizontally or obliquely arranged in the housing body.

10. The double outlet capsule packing container according to claim 8, wherein, a protrusion portion is provided on a contacting area between a bottom of the partition portion and a bottle mouth.

11. The double outlet capsule packing container according to claim 9, wherein, a protrusion portion is provided on a contacting area between a bottom of the partition portion and a bottle mouth.

12. The double outlet capsule packing container according to claim 10, wherein, the protrusion portion is a protruded block, a protruded point, or a rhombic corner.

13. The double outlet capsule packing container according to claim 11, wherein, the protrusion portion is a protruded block, a protruded point, or a rhombic corner.

14. The double outlet capsule packing container according to claim 10, wherein: an anti-leak area is provided at a connection position between the housing body and the partition portion.

15. The double outlet capsule packing container according to claim 11, wherein: an anti-leak area is provided at a connection position between the housing body and the partition portion.

16. The double outlet capsule packing container according to claim 14, wherein, the anti-leak area is an anti-leak ring.

17. The double outlet capsule packing container according to claim 15, wherein, the anti-leak area is an anti-leak ring.
